(19) United States
(12) Patent Application Publication
(10) Pub. No.: US 2002/0172166 A1
(43) Pub. Date: Nov. 21, 2002

(54) Communications system and method for measuring short-term and long-term channel characteristics

(76) Inventors: Huseyin Arslan, Durham, NC (US); Karl J. Molnar, Cary, NC (US); Gregory E. Bottomley, Cary, NC (US); Ali S. Khayrallah, Apex, NC (US)

Correspondence Address: MOORE & VAN ALLEN, PLLC, 2200 W MAIN STREET, SUITE 800, DURHAM, NC, 27705, US

(21) Appl. No.: 09/814,889

(22) Filed: Mar. 22, 2001

(51) Int. Cl. H04B 7/185

(52) U.S. Cl. 370/317; 370/332

(57) ABSTRACT

A communications system and method for compensating for an interferer signal in a received signal comprising a radio processor for filtering the received signal, and a demodulator coupled to the radio processor for demodulating the filtered received signal. A channel quality estimator coupled to the demodulator determines a channel characteristic based on instantaneous noise values of the received signal, for controlling the demodulation of the received signal to compensate for the interferer signal responsive to the channel characteristic. Further, where the channel characteristic is a first channel characteristic, the channel quality estimator determines a second channel characteristic based on instantaneous noise values of the received signal and controls demodulation of the received signal to compensate for the interferer signal responsive to the first and the second channel characteristics.

### BACKGROUND OF THE INVENTION

The present invention is directed to a system and method for measuring channel characteristics in a mobile communications system, and more specifically, to a system and method for measuring short-term and long-term channel characteristics to compensate for an interferer in a received signal.

In a mobile communications system, a mobile terminal (for example, a cellular telephone) communicates with a base station via a communications channel. A signal is received, and processed by a radio processor to obtain its baseband components. The baseband signal is further processed by a demodulator which extracts desired information from the received signal. The demodulator compensates for distortion resulting from transmission of the signal over the communications channel, for example, by compensating for multipath transmission, fading and interfering signals.

Communications channel characteristics, for example, symbol error rate, bit error rate, frame error rate, received signal strength measurement and signal-to-noise ratio (SNR) may be used in the receiver and/or transmitter to improve capacity and signal quality of the system. For example, such information can be used in altering the adaptation parameters, improving the soft bit information or the symbol values. One approach of using channel quality measurements utilizes the SNR over the training sequences for several time slots, to determine long-term fading statistics due to shadowing and log-normal fading.

Another approach uses long-term SNR information derived from the cumulative Euclidian metric corresponding to the decoded trellis path as a channel characteristic for rate adaptation. A third approach utilizes a difference between Maximum likelihood decoder metrics between a best and second best path in conjunction with a soft information measurement as a channel characteristic.

### SUMMARY OF THE INVENTION

A mobile communications system and method are provided for compensating for an interferer signal in a received signal comprising a radio processor for filtering and down-sampling the received signal, and a demodulator coupled to the radio processor for demodulating the filtered received signal. A channel quality estimator coupled to the demodulator determines a channel characteristic based on instantaneous noise values of the received signal, for controlling the demodulation of the received signal to compensate for the interferer signal responsive to the channel characteristic.

In a further embodiment, the channel characteristic is a first channel characteristic, and the channel quality estimator determines a second channel characteristic based on instantaneous noise values of the received signal and controls the demodulation of the received signal to compensate for the interferer signal responsive to the first and second channel characteristics.

In another embodiment, the channel quality estimator determines the channel characteristic utilizing an adaptively changeable smoothing factor.

### BRIEF DESCRIPTION OF THE DRAWINGS

FIG. 1 illustrates a block diagram of a radio communications system in accordance with the invention;

FIGS. 2a and 2b illustrate the change in location of an interferer slot with reference to a desired user slot in a system utilizing discontinuous transmission and/or power control;

FIG. 3 illustrates a block diagram of the receiver of FIG. 1 in accordance with an embodiment of the invention;

FIG. 4 illustrates a block diagram of the receiver of FIG. 1 utilizing selective joint demodulators in accordance with another embodiment of the invention;

FIG. 5a is a flowchart illustrating operation of the receiver of FIG. 1 utilizing long term channel characteristics;

FIG. 5b is a flowchart illustrating operation of the receiver of FIG. 1 utilizing short term channel characteristics;

FIG. 5c is a flowchart illustrating operation of the receiver of FIG. 1 utilizing both the long term and short term channel characteristics;

FIG. 6 illustrates a block diagram of the receiver of FIG. 1 utilizing parallel joint demodulators in accordance with an embodiment of the invention;

FIG. 7 is a graph of short-term channel quality values when interference is suddenly present; and

FIG. 8 is a block diagram of a receiver in accordance with another embodiment of the invention.

### DETAILED DESCRIPTION OF THE INVENTION

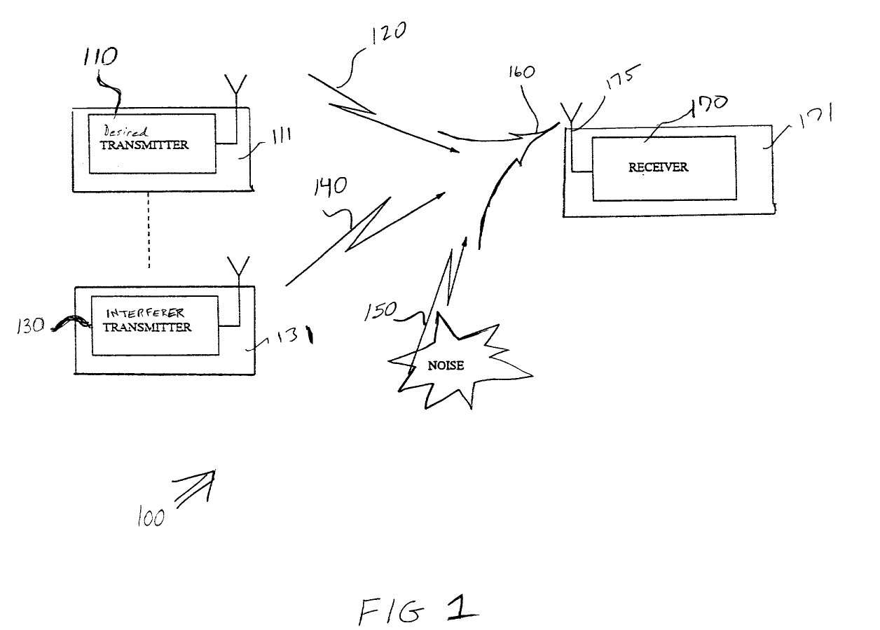

FIG. 1 illustrates a mobile communications system 100 (e.g., a radio communications system) in accordance with the invention. The mobile communications system 100 includes a desired transmitter 110 for transmitting a desired signal 120, one or more interferer transmitters 130 for transmitting one or more interferer signals 140, and noise 150, for example, Gaussian noise. The desired signal 120, the one or more interferer signals 140 and the noise 150 are received as a received signal 160 at a receiver 170. For simplicity, only two transmitters and one receiver are shown in FIG. 1. However, the proposed invention can be applied to more than two transmitters and a receiver. The receiver 170 may be a receiver of a base station 171 while the transmitters 110 and 130 are associated with respective mobile terminals 111 and 131, as is known. Alternatively, the receiver 170 could be the receiver in a mobile terminal, while the transmitters 110 and 130 could be transmitters in base stations, or any combination thereof.

As used herein, the term “mobile terminal” may include a mobile communications radio telephone with or without a multi-line display; a personal communications system (PCS) terminal that may combine a mobile communications radio telephone with data processing, facsimile and data communications capability; a PDA that can include a radio telephone, pager, Internet-Intranet access; web browser, organizer, calendar and/or a global positioning system (GPS) receiver; and a conventional laptop and/or Palm® top receiver or other appliance that includes a radio telephone transceiver. Mobile terminals may also be referred to as “pervasive computing” devices.

The invention is described under the assumption that the desired transmitter 110 transmits desired information signals 120, and the other transmitters, such as the interferer transmitter 130, transmits interfering signals 140, also referred to as “interferers.” The receiver 170 attempts to receive the desired information signal 120 correctly under the presence of the interferer signal 140 and thermal noise 150. The transmitted signals 120 and 140 plus thermal noise 150 are received at the receiver 170 via a receiver antenna 175. While a single receiver antenna 175 is shown, the receiver 170 could have more than one antenna.

The mobile communications system 100 may be, for example, a digital advanced mobile phone system (DAMPS) using downlink slot and transmission format, where root raised cosine pulse shaping is considered both in the transmitters 110 and 130 and the receiver 170. Another example system is the global system for mobile communications (GSM). The transmission/propagation mediums, for example, may be mobile radio channels such as frequency non-selective Rayleigh fading channels using a 900 MHz carrier frequency for both the desired signal 120 and the interferer signal 140, where the channel is simulated using Jake's fading model.

Consider the DAMPS system. In a time-division multiple access (TDMA) frame, the desired signal 120 is transmitting all of the time. Every 20 ms the desired signal transmits information sequences twice having a slot duration of 6.667 ms. Weak interferers are included in the noise 150. A strong interferer 140 is separated from the other impairments (for example, noise) under the assumption that when the noise is large, it is due to the strong interferer, which usually occurs due to tunneling effects.

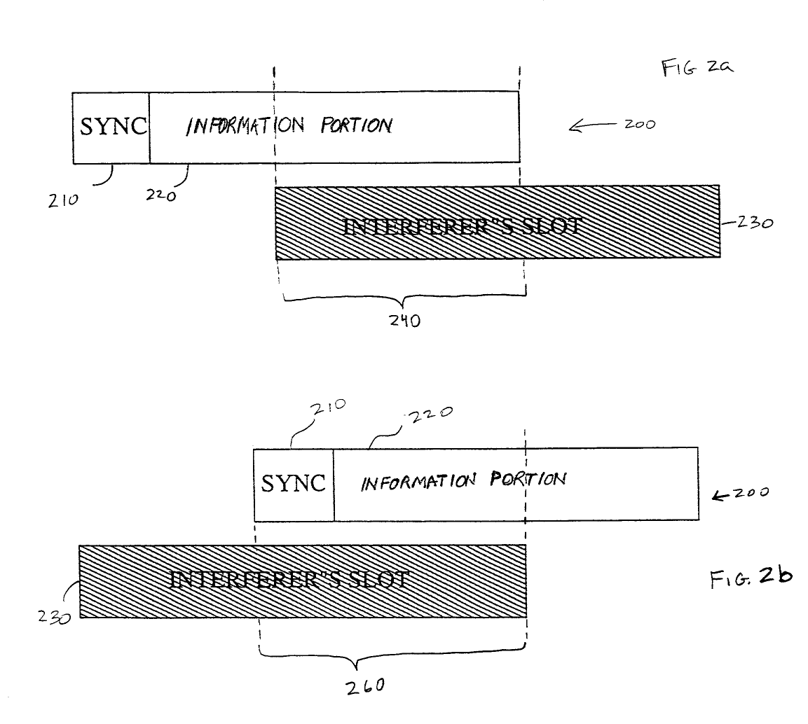

In some cases, for example, where discontinuous transmission and/or power control are used, the signal power or location of the interferer signal 140 may differ from timeslot to timeslot with respect to the desired signal 120, as shown in FIGS. 2a and 2b.

The interferer signal 140 may be both slot and symbol misaligned with respect to the desired signal 120, where the slot misalignment is random with respect to a center of the desired signal 120. The symbol misalignment may be random with respect to the desired signal 120, where an oversampling ratio of eight is used. For example, FIG. 2a illustrates a desired user timeslot 200 of the desired signal 120 including a syncword portion 210 and an information portion 220. An interferer timeslot 230 of the interferer signal 140 overlaps the desired user timeslot 200 in a first region 240. Because of discontinuous transmission and/or power control, a consecutively transmitted desired user timeslot 200 of FIG. 2b is overlapped by the interferer slot 230 in a second region 260, different from the first region 240. The receiver 170 compensates for the interferer signal 140 in such cases. The interferer may not be present in the received signal 160 all the time, but may be intermittent.

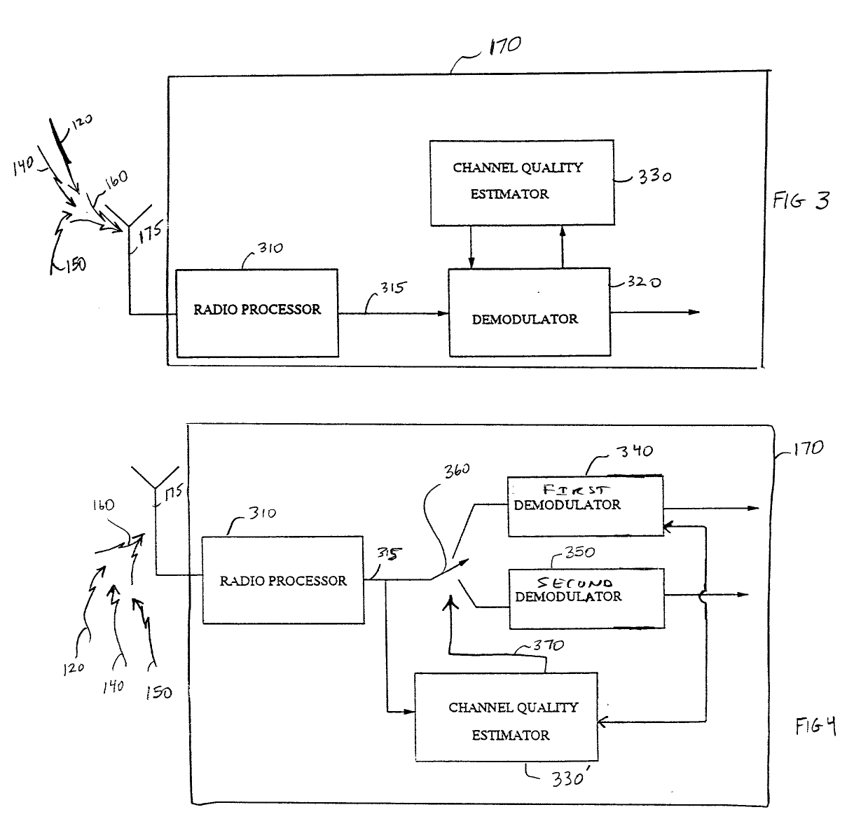

FIG. 3 illustrates the receiver 170 of FIG. 1 in accordance with an embodiment of the invention. The received signal 160 is received at the antenna 175. A radio processor 310 coupled to the antenna 175 processes the received signal 160 by amplifying, mixing, filtering, sampling and quantifying the received signal to produce baseband signal samples. The baseband signal samples are sent to a demodulator 320 via a line 315 coupled to the radio processor 310, which demodulates the processed signal samples. Metric values for the processed signal samples are sent from the demodulator 320 to a channel quality estimator 330, coupled to the demodulator 320, which measures a channel characteristic based on instantaneous noise values. The channel characteristic based on instantaneous noise values is passed from the channel quality estimator 330 to the demodulator 320, where the signal is processed responsive to the channel characteristic to compensate for the interferer signal 140.

The demodulator 320 may, for example, produce soft values which are supplied to a decoder (not shown). Channel encoding is frequently used in transmitters to provide redundancy by adding extra bits to the actual information bits. In the receiver 170, the decoder decodes the encoded bits while detecting and correcting possible errors in the received signal. Additional blocks, such as interleaving, and the like, are not mentioned herein for purposes of simplicity.

The channel characteristics based on instantaneous noise values are short-term channel quality values (STC) and long-term channel quality values (LTC) which may be tracked by the channel quality estimator 330 separately or in combination. Signal samples over the whole slot are used to determine the STC, where the mean STC over each slot is used to obtain the LTC. The LTC is used to determine whether the interferer signal 140 is present in the received signal 160, where the STC is utilized to determine whether the interferer signal 140 is on or off for particular signal samples of the received signal 160.

In generating the STC and the LTC, initial channel estimates for the desired signal 120 are determined over the syncword. The initial channel estimates and the known sync fields are used to determine the average error between the received signal 160 at the antenna 175 and a signal reconstructed by the demodulator 320 as

$${e}_{av} = \frac{1}{N} {\sum }_{n = 1}^{N} {\vert {r}_{n} - {\hat{c}}_{n} {S}_{n} \vert}^{2} , \qquad ( 1 )$$

where received signal samples of the received signal 160 are given as

rₙ=Sₙcₙ+Iₙhₙ+zₙ, (2)

and where Iₙ is the interfering waveform sampled at tine n, hₙ is the interfering channel, zₙ is the thermal noise term (including weak interferers and other impairments), ĉₙ is the channel estimate for the desired signal, Sₙ is the known desired symbol value, and N is the length of the syncword. The average error expression given in (1) can also be extended when there is dispersion in the desired signal. In the data fields of the received signal 160, instantaneous errors are found by finding the minimum metric using all hypotheses of the symbol values and the channel estimates as

$${e}_{i n s t} ( n ) = {min}_{{S}_{n}^{H}} \vert {r}_{n} - {\hat{c}}_{n} {S}_{n}^{H} {\vert}^{2} , \qquad ( 3 )$$

where Sₙ^{H} is the symbol hypothesis and n represents the number of samples per time slot. Alternate forms of this metric that don't find a minimum value can also be used. Also other metrics can be used. The instantaneous error values are very noisy, and thus makes it difficult to get an idea about the average noise level. Thus, the instantaneous noise values are computed as an average using the instantaneous error values as

eₐᵥ(n)=eₐᵥ(n−1)β+(1−β)eᵢₙₛₜ(n), (4)

which represents the STC for each sample of the received signal 160, where β (a smoothing factor) determines the tracking ability of the average noise value. It is desirable that β is close to 1 to reduce the instantaneous fluctuations of the noise value. However, as it is also desirable to detect sudden changes in the noise estimates when the interferer signal 140 appears or disappears within the slot (edge detection) due to slot misalignment, adaptively changing β during the slots prevents blurring of the edges of the interferer signal 140. β may be adaptively changed as

$$\tilde{β} ( n ) = β - \vert {\sum }_{k = n - L}^{n} {e}_{av} ( k ) - {e}_{av} ( k - 1 ) \vert \cdot {λ}_{1} \qquad ( 5 )$$

where λ₁ is a normalization factor and where L may be any number of samples, but is preferably between 5 and 10. \tilde{β} may be restricted to a lower limit, for example, 0.7, to prevent too great of a change in the noise estimate.

To calculate the LTC, an average noise value over each slot is determined using the equation

$${\tilde{e}}_{av} = \frac{1}{M} {\sum }_{m = 1}^{M} {e}_{inst} ( m ) , \qquad ( 6 )$$

where M represents a number of symbols within the time slot. The division by M may be omitted. The LTC is calculated as

e_{long}(u)=e_{long}(u−1)γ+(1−γ)\tilde{e}ₐᵥ(u), (7)

where γ (a smoothing factor) determines the tracking ability of the long term noise estimate, and u represents a number of time slots over which the LTC is calculated. As with β, γ may be changed adaptively depending on differences of the LTC as

$$\tilde{γ} ( n ) = γ - \vert {\sum }_{k = n - L}^{n} {e}_{long} ( k ) - {e}_{long} ( k - 1 ) \vert \cdot {λ}_{2} \qquad ( 8 )$$

where γ₂ is a normalization factor. The LTC provides an indication as to whether the strong interferer is present or not in a particular time slot. As with \tilde{β}, \tilde{γ} may be restricted to a lower limit of, for example, 0.7.

In an alternate embodiment, the LTC is determined by averaging eₐᵥ(n) over a plurality of “T” time slots. For example, corresponding samples of eₐᵥ(1), eₐᵥ(2) through eₐᵥ(n) are averaged for the T time slots yielding e_{Tav}(1) through e_{Tav}(n), where T may be, for example 10. The values e_{Tav}(1) through e_{Tav}(n) are added together, where the sum may be divided by n, yielding e_{Tav}(u). The LTC is then calculated as

e_{long}(u)=e_{long}(u−1)γ+(1−γ)e_{Tav}(u). (9)

Using the e_{Tav}(u) for the LTC determination provides a more accurate determination of the presence of the interferer signal 140 by reducing the effects of the white noise 150 within the received signal 160.

Returning to FIG. 3, the demodulator 320 determines whether the interferer signal 140 is present using the LTC. Where the interferer signal 140 is present, the demodulator 320, for example, alters adaptation parameters or soft information generated by the demodulator 320 to compensate for the interferer signal 140. Further, the STC could be used by the demodulator 320 to further alter, for example, adaptation parameters or soft information on a sample by sample basis to compensate for the interferer signal 140 within a timeslot. The STC and the LTC over a slot may be used to normalize the soft information values of the demodulator 320. The STC is particularly useful in the case where the interferer signal 140 is not constant over the entire slot, as the soft information generation may be altered on a sample by sample basis depending on whether the interferer signal 140 is on or off for particular samples of the received signal 160. Alternatively, the STC may be used within the slot to adjust other receiver parameters, such as channel tracking parameters. If the interferer signal 140 is high, adaptation parameters may be reduced, whereas if the interferer signal 140 is low or does not exist, the adaptation parameters may be increased.

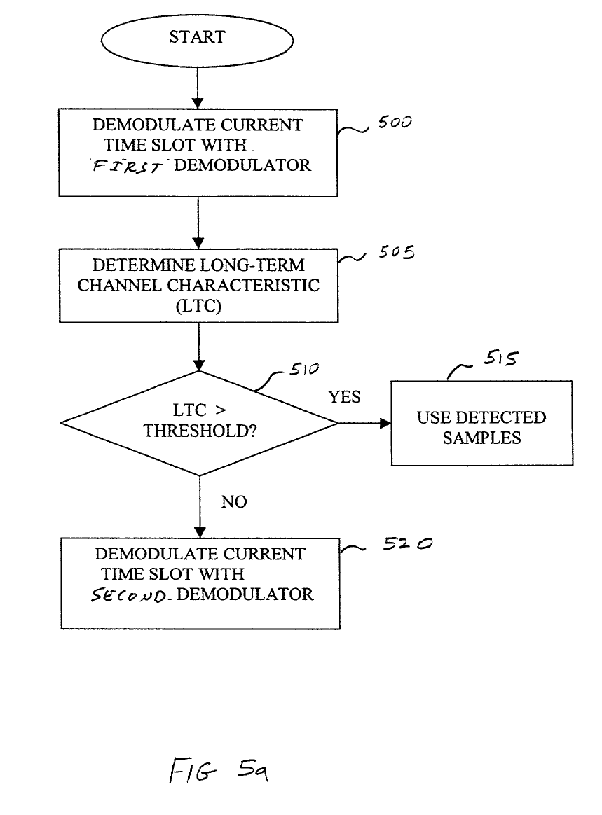

FIG. 4 illustrates a receiver 170′ utilizing multiple demodulators in accordance with another embodiment of the invention. Components of FIG. 4 having the same reference numerals as components of FIG. 3 are the same and will not be discussed in detail. FIG. 4 shows multiple demodulators, namely, a first, possibly less complex demodulator 340 and a second, possibly more complex demodulator 350, selectively coupled to the radio processor 310 and receiving the processed signal 315 by a selector 360. The selector 360 is controlled by a channel quality estimator 330′ via a control line 370.

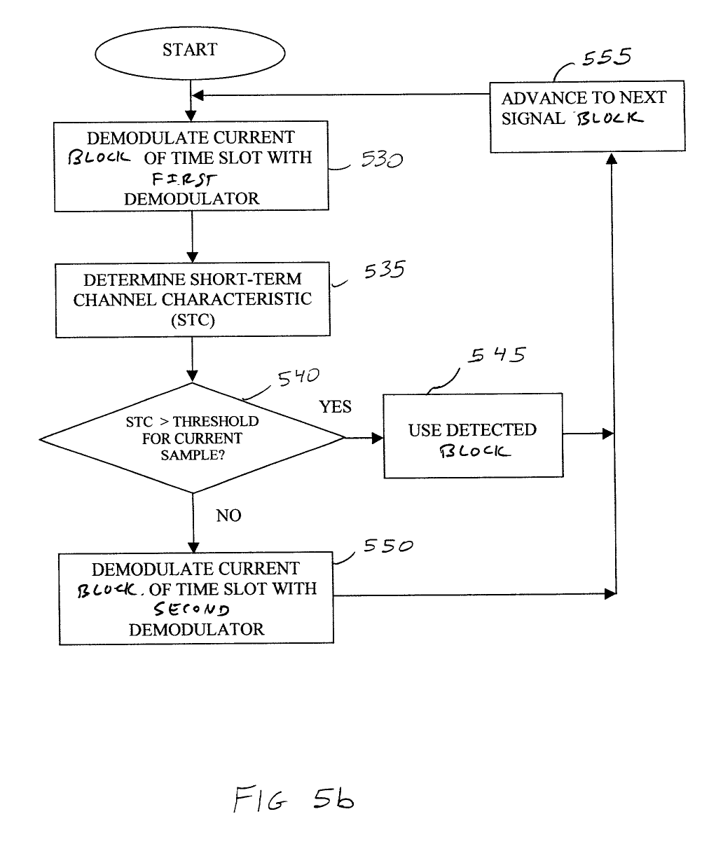

Specifically, the first demodulator 340 is better adapted for demodulating some channel conditions, for example, the presence of little or no interferer signal 140, and the second demodulator 350 is better adapted for demodulating other channel conditions, for example the presence of the interferer signal 140. The first demodulator 340 may be, for example, a demodulator utilizing differential detection, coherent demodulation, equalization, and joint co-channel signal demodulation (or equalization), all of which are known to one skilled in the art. The second demodulator 350 utilizes a more complex demodulating scheme than the first demodulator 340, for to example, a demodulator utilizing differential detection, coherent demodulation, equalization, and joint co-channel signal demodulation (or equalization), which is suitable for compensating for the interferer signal 140. For example, the first demodulator 340 may be a demodulator utilizing differential detection, where the second demodulator 350 may be a demodulator utilizing equalization. Alternatively, both demodulators 340 and 350 may utilize equalization, where, for example, the channel tracking parameters utilized by the first demodulator 340 are better adapted for demodulating the received signal having little or no interferer signal, and the channel tracking parameters utilized by the second demodulator 350 are better adapted for demodulating the received signal including the interferer signal. Selection of the first demodulator 340 or the second demodulator 350 is made based on one or both of the LTC and the STC, further discussed below with reference to the flow charts of FIGS. 5a-5c, which illustrate operation of the receiver 170′.

FIG. 5a is a flowchart illustrating operation of the receiver 170′ utilizing the LTC based on instantaneous noise values, where the LTC indicates whether the interferer signal 140 is present within a current timeslot of the received signal 160. In step 500, the channel quality estimator 330′ actuates the selector 360 to cause the first demodulator 340 to demodulate the processed signal samples, where the results of the demodulation from the first demodulator 340 is used by the channel quality estimator 330′ to determine the LTC, step 505. The channel quality estimator 330′ may determine the LTC as discussed above with reference to equations (6)-(9). Where the LTC exceeds a predetermined LTC threshold value indicating that no strong interferer signal 140 is present in the current timeslot, step 510, the samples demodulated by the first demodulator 340 are utilized as shown in step 515. However, where the LTC does not exceed the predetermined threshold LTC value in step 510, indicating the presence of a strong interferer signal 140 in the current timeslot of the received signal 160, the channel quality estimator 330′ actuates the selector 360 through the control line 370 to cause the second demodulator 350 to demodulate the processed signal 315 for the slot, as shown in step 520.

FIG. 5b is a flowchart illustrating operation of the receiver 170′ utilizing the STC based on instantaneous noise values, where the STC indicates whether the interferer signal 140 is present in particular samples or blocks of samples of the received signal 160 for a particular timeslot. In step 530, the channel quality estimator 330′ actuates the selector 360 to cause the first demodulator 340 to demodulate a current processed signal block (one or more samples), step 530, where the results of the demodulation from the first demodulator 340 is used by the channel quality estimator 330′ to determine the STC, step 535. The STC may be determined as discussed above with references to equations (3)-(5). In step 540, where the STC exceeds a predetermined STC threshold for a block, indicating that a strong interferer is not present for that block, the block demodulated by the first demodulator 340 is utilized, step 545. However, where the STC does not exceed the predetermined STC threshold in step 540, indicating the presence of a strong interferer for that block, the channel quality estimator 330′ actuates the selector 360 through the control line 370 to select the second demodulator 350 to demodulate the processed signal 315 for that signal block, step 550. The channel quality estimator 330′ then causes the selector 360 to select the first demodulator 340 to demodulate a next block of the slot, step 555, and the method returns to step 530.

FIG. 5c is a flowchart illustrating operation of the receiver 170′ utilizing both the LTC and the STC based on instantaneous noise values. Steps having the same reference numeral as steps in FIGS. 5a and 5b are the same and will not be discussed in detail. Specifically, where the LTC is greater than the predetermined LTC threshold in step 510, no strong interferer signal 140 is present in the received signal 160, and the detected signal samples are used as shown in step 515. However, where the LTC is not greater than the predetermined LTC threshold in step 510, indicating the presence of the interferer signal 140 within the received signal 160 for that time slot, the current block of samples of the timeslot is demodulated using the first demodulator 340, step 530. The channel quality estimator 330′ determines the STC, as shown in step 535. Where the STC is greater than a predetermined STC threshold for the current block, the strong interferer signal 140 is not present for that block, and the detected block is utilized as shown in step 545. However, where the STC is not greater than the predetermined STC threshold for the current block in step 540, the channel quality estimator 330′ actuates the selector 360 via control line 370 to select the second demodulator 350 to demodulate the current block of the timeslots, step 550. In step 560 it is determined whether or not there are more samples in the current timeslot. Where more samples exist in the current timeslot, the method returns to step 530 where a next block of samples of the current timeslot is demodulated with the first demodulator 340. However, where there are no more samples in the current timeslot, the method returns to step 500 where a next timeslot is demodulated with the first demodulator 340.

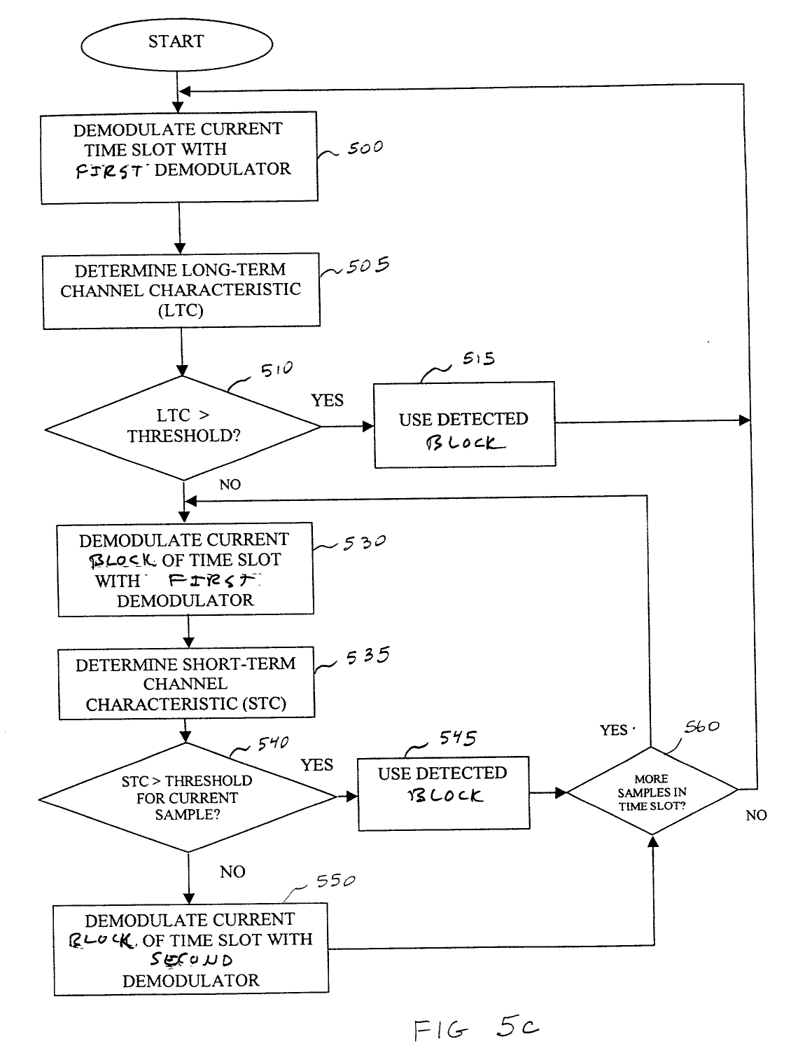

FIG. 6 illustrates a receiver 170″ utilizing consecutive demodulators in accordance with an embodiment of the invention. Components of FIG. 6 having the same reference numerals as components of FIG. 4 are the same and will not be discussed in detail. Similar to FIG. 4, the receiver 170″ of FIG. 6 utilizes the first demodulator 340 and the second demodulator 350 to demodulate the processed signal 315. However, unlike in FIG. 4, the first demodulator 340 and the second demodulator 350 are both coupled to the radio processor 310 and operate in parallel. The channel quality estimator 330″ is coupled to both the first demodulator 340, the second demodulator 350 and to a combiner 500 having a combiner output node 510. The combiner 500 is further coupled to both the first demodulator 340 and the second demodulator 350, where the channel quality estimator 330″, based on at least one of the LTC and the STC, causes the combiner 500 to select one of a signal produced by the first demodulator 340 and the second demodulator 350 to be provided at the combiner output node 510. The selection is performed in a similar fashion as discussed above with reference to FIG. 4 and FIGS. 5a-5c. Thus, where the LTC exceeds a predetermined LTC threshold, the channel quality estimator 330″ causes the combiner 500 to select the signal produced by the first demodulator 340 to be provided at the combiner output node 510, as little or no interferer signal 140 is present. However, where the LTC does not exceed the predetermined LTC threshold, the channel quality estimator 330″ causes the combiner 500 to select a signal from the second demodulator 350 as a signal provided at the combiner output node 510, as the interferer signal 140 is present. In a further embodiment, where the channel quality estimator 330″ further utilizes an STC, the channel quality estimator 330″ causes the combiner 500 to provide samples of the signal produced by the first demodulator 340 at the combiner output node 510 where the STC corresponding to the received signal samples exceed a predetermined STC threshold, and causes the samples of the signal produced by the second demodulator 350 to be provided at the combiner output node 510 where the STC for corresponding samples of the received signal does not exceed the predetermined STC threshold.

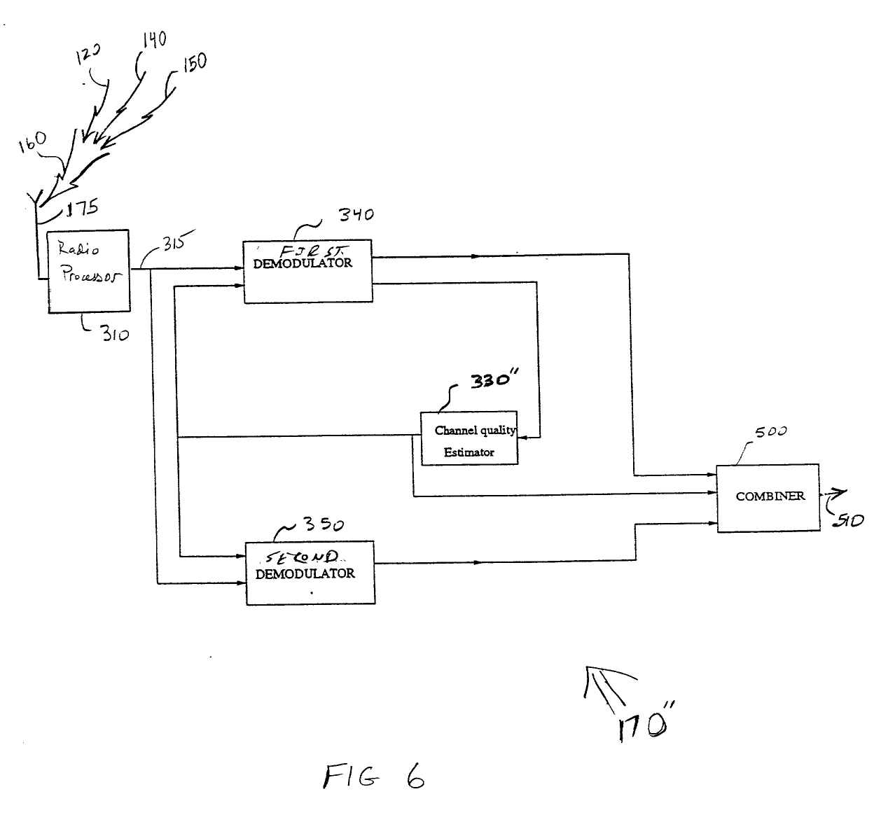

Referring again to FIG. 2a, the present invention can be used to demodulate the portion of the slot with interference differently from the portion of the slot without interference. Which portion of the slot has interference can be determined by examining the STC. An example is shown in FIG. 7. Observe that the STC suddenly changes in value when interference is suddenly present. A similar change would occur for the scenario in FIG. 2b. This change is detected and used to determine when, within a slot, to switch from a first demodulator to a second demodulator. For that example in FIG. 2a, the first demodulator could be a single user detector whereas the second demodulator could be one that jointly demodulates two signals.

The STC from a single slot may be too noisy to determine a switching time, so it may be advantageous to average, for each sample location or location of a block of samples, the STC. This can be done using, for example, exponential smoothing. Note that the switching time is a relative time, relative to the beginning of the slot or some other time of reference. It can also be expressed as an absolute time.

The interference situation will change slowly with time. Thus, it is important to re-examine the switching time or even if there is any interference. This can be done, for example, by occasionally demodulating the whole slot with a single user demodulator. Alternatively, control functions described in Arslan et al. pending application Ser. No. 09/660,050, filed Sep. 12, 2000, and owned by the assignee of the present application, can be applied to different portions of the slot, using the sync words of the different users, to determine whether the interferer is still present.

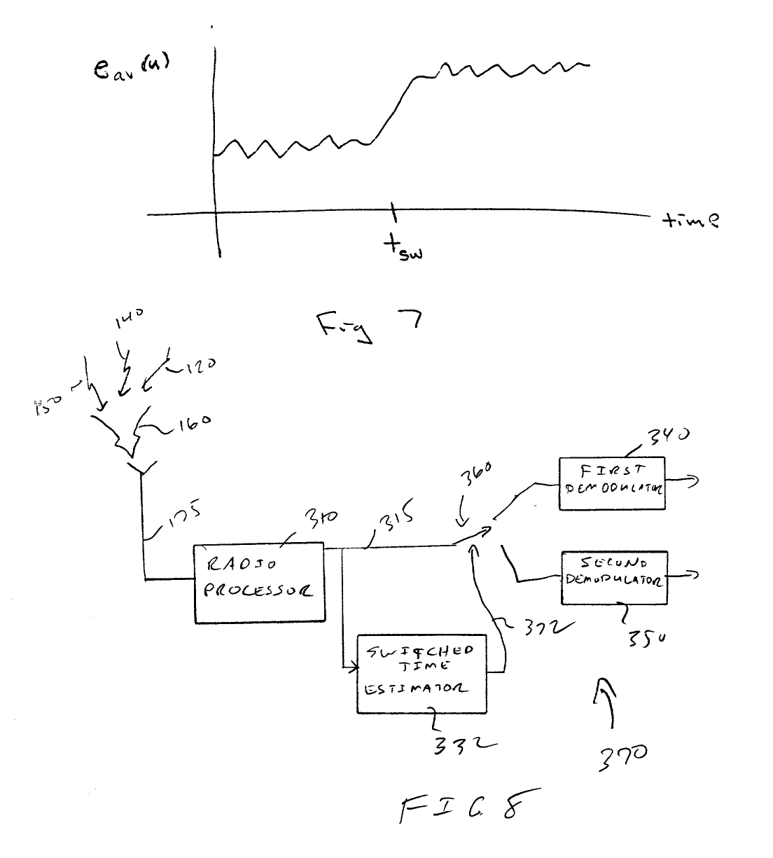

FIG. 8 illustrates a receiver 370 utilizing multiple demodulators in accordance with another embodiment of the invention. Components of FIG. 8 having the same reference numerals as components of FIG. 4 are the same and will not be discussed in detail. FIG. 8 shows multiple demodulators, a first demodulator 340 and a second demodulator 350, selectively coupled to the radio processor 310 and processed signal 315 by the selector 360. The selector 360 is controlled by a switching time estimator 332 via a control line 372.

Specifically, the first demodulator 340 is a single user detector, better adapted for the presence of little or no interferer signal 140, and the second demodulator 350 is a multiuser detector better adapted for demodulation in the presence of another interfering user. Different portions of the received signal are processed by different demodulators, according to the position of the selector 360 as determined by the switching time estimator 332 via the control line 372.

The switching time estimator 332 determines which portion of the slot, if any, contains a dominant interferer and which portion, if any, has no dominant interferer. In one embodiment of the switching time estimator, STC values from the first demodulator 340 are averaged over multiple slots. Edge detection is then used to determine if there is a sudden change, indicating the presence of an interferer. A simple form of edge detection is to estimate the derivative of the STC values by taking differences between the STC values at adjacent sample positions. The peak of these derivative values can then be used to determine a position where there is a large change. The derivative can be compared to a threshold to determine if the change is significant. More advanced forms of edge detection, as developed in the signal processing art, can be used.

Once a potential switching time has been identified, if any, further processing can be used to validate that position. One approach would be to look for the sync word of the interferer based on the potential switching time.

To continually monitor the switching time, it may be advantageous to always demodulate the whole slot using the first demodulator, but to only use the second demodulator on portions of the received signal where a dominant interferer is present. In this case, the selector 360 in FIG. 8 would be replaced with a device that always provides the signal to the first demodulator 340 but selectively provides the signal to demodulator 350.

The present invention has been described with respect to flowcharts and block diagrams. It will be understood that each block of the flowchart and block diagrams can be implemented by computer program instructions. These program instructions may be provided to a processor to produce a machine, such that the instructions which execute on the processor create means for implementing the functions specified in the blocks. The computer program instructions may be executed by a processor to cause a series of operational steps to be performed by the processor to produce a computer-implemented process such that the instructions which execute on the processor provide steps for implementing the functions specified in the blocks. Accordingly, the illustrations support combinations of apparatus and methods for performing a specified function and combinations of steps for performing the specified functions. It will also be understood that each block and combination of blocks can be implemented by special purpose hardware-based systems which perform the specified functions or steps, or combinations of special purpose hardware and computer instructions.

Still other aspects, objects and advantages of the invention can be obtained from a study of the specification, the drawings and the appended claims. It should be understood, however, that the invention could be used in alternate forms where less than all the objects and advantages of the invention and preferred embodiments as described above would be obtained.

We claim:

1. A method for compensating for an interferer signal in a received signal for a communications system comprising:
measuring a channel characteristic based on instantaneous noise values of the received signal; and
compensating for the interferer signal in the received signal by processing the received signal responsive to the channel characteristic.

2. The method of claim 1 wherein the channel characteristic is a long-term channel characteristic measured from a plurality of time slots of the received signal for detecting presence of an interferer in the received signal.

3. The method of claim 2 wherein the long-term channel characteristic measured from a plurality of time slots of the received signal comprises a long-term noise value estimate calculated by adding a previous time slot long term noise estimate using a smoothing factor.

4. The method of claim 3 further comprising adaptively changing the smoothing factor.

5. The method of claim 2 wherein the long-term channel characteristic measured from a plurality of time slots of the received signal comprises averaging instantaneous noise values over the plurality of time slots by summing corresponding instantaneous noise value samples from each of the plurality of time slots.

6. The method of claim 1 wherein the channel characteristic is a short-term channel characteristic measured from a time slot of the received signal for indicating a location of the interferer signal in the time slot of the received signal.

7. The method of claim 6 wherein the short-term channel characteristic measured from a time slot of the received signal is calculated by adding an average of the instantaneous noise value for a previous sample of the time slot multiplied by a smoothing factor with an instantaneous error value from a current sample of the time slot multiplied by one less the smoothing factor.

8. The method of claim 7 further comprising adaptively changing the smoothing factor.

9. The method of claim 1 wherein the channel characteristic is a first channel characteristic, and further comprising measuring a second channel characteristic based on instantaneous noise values of the received signal; and
compensating for the interferer signal in the received signal comprises processing the received signal responsive to the first and second channel characteristics.

10. The method of claim 9 wherein the first channel characteristic based on instantaneous noise values of the received signal is a long-term channel characteristic measured from a plurality of time slots of the received signal for detecting the presence of an interferer in the received signal, and the second channel characteristic based on instantaneous noise values is a short-term channel characteristic measured from at least one time slot of the received signal for indicating a location of the interferer signal in the received signal.

11. The method of claim 1 wherein compensating for interference in the received signal by processing the received signal responsive to the channel characteristic comprises selecting a demodulator for processing the received signal responsive to the channel characteristic.

12. The method of claim 1 wherein compensating for interference in the received signal by processing the received signal responsive to the channel characteristic comprises changing adaptation parameters of a demodulator responsive to the channel characteristic.

13. The method of claim 1 wherein compensating for interference in the received signal by processing the received signal responsive to the channel characteristic comprises changing soft information values of a demodulator responsive to the channel characteristic.

14. The method of claim 13 wherein changing of soft information values of a demodulator responsive to the channel characteristic comprises normalizing the soft information values of the demodulator.

15. A receiver for compensating for an interferer signal in a received signal comprising:
a radio processor for filtering the received signal;
a demodulator coupled to the radio processor for demodulating the filtered received signal; and
a channel quality estimator coupled to the demodulator for determining a channel characteristic based on instantaneous noise values of the received signal for controlling the demodulation of the received signal to compensate for the interferer signal responsive to the channel characteristic.

16. The receiver of claim 15 wherein the channel characteristic is a long-term channel characteristic measured from a plurality of time slots of the received signal for detecting the presence of an interferer in the received signal.

17. The receiver of claim 16 wherein the long-term channel characteristic measured from a plurality of time slots of the received signal comprises a long-term noise value estimate, and the channel quality estimator calculates the long term noise value estimate by adding a previous time slot long term noise estimate using by a smoothing factor.

18. The receiver of claim 17 wherein the channel quality estimator adaptively changes the smoothing factor.

19. The receiver of claim 16 wherein the long-term channel characteristic measured from a plurality of time slots of the received signal comprises averaging instantaneous noise values over the plurality of time slots calculated by the channel quality estimator by summing corresponding instantaneous noise value samples from each of the plurality of time slots.

20. The receiver of claim 15 wherein the channel characteristic is a short-term channel characteristic measured from a time slot of the received signal for indicating a location of the interferer signal in the time slot of the received signal.

21. The receiver of claim 20 wherein the short-term channel characteristic measured from a time slot of the received signal is calculated by the channel quality estimator by adding an average of the instantaneous noise value for a previous sample of the time slot using a smoothing factor.

22. The receiver of claim 21 wherein the channel quality estimator adaptively changes the smoothing factor.

23. The receiver of claim 15 wherein the channel characteristic is a first channel characteristic, and further comprising the channel quality estimator determining a second channel characteristic based on instantaneous noise values of the received signal and controlling demodulation of the received signal to compensate for the interferer signal responsive to the first and second channel characteristics.

24. The receiver of claim 23 wherein the first channel characteristic based on instantaneous noise values of the received signal is a long-term channel characteristic measured from a plurality of time slots of the received signal for detecting the presence of an interferer in the received signal, and the second channel characteristic based on instantaneous noise values is a short-term channel characteristic measured from at least one time slot of the received signal for indicating a location of the interferer signal in the received signal.

25. The receiver of claim 15 wherein the demodulator is a first demodulator and further comprising a second demodulator coupled to the radio processor and the channel quality processor for demodulating the filtered received signal, wherein the channel quality estimator selects one of the first demodulator and the second demodulator for demodulating the filtered received signal responsive to the channel characteristic.

26. The receiver of claim 15 wherein the demodulator is a first demodulator and further comprising a second demodulator coupled to the radio processor and the channel quality processor for parallel demodulation of the filtered received signal, and further comprising a combiner coupled to the channel quality processor, and to the first and second demodulators, wherein the channel quality estimator causes the combiner to select one of the demodulated signal from the first demodulator and the second demodulator responsive to the channel characteristic.

27. The receiver of claim 15 wherein the channel quality estimator controls the demodulation responsive to the channel characteristic by changing adaptation parameters of a demodulator responsive to the channel characteristic.

28. The receiver of claim 15 wherein the channel quality estimator controls the demodulation responsive to the channel characteristic by changing soft information of a demodulator responsive to the channel characteristic.

29. The receiver of claim 28 wherein the channel quality estimator changes the soft information values of the demodulation responsive to the channel characteristic by normalizing the soft information values of the demodulator.

30. A mobile terminal for use in a mobile communications system comprising:
a receiver for receiving a signal comprising a desired signal and an interferer signal;
a radio processor for filtering the signal;
a demodulator coupled to the radio processor for demodulating the filtered signal; and
a channel quality estimator coupled to the demodulator for determining a channel characteristic based on instantaneous noise values of the signal for controlling the demodulation of the signal such that the desired signal is extracted by compensating for the interferer signal responsive to the channel characteristic.

31. The mobile terminal of claim 30 wherein the channel characteristic is a long-term channel characteristic measured from a plurality of time slots of the received signal for detecting the presence of an interferer in the received signal.

32. The mobile terminal of claim 30 wherein the channel characteristic is a short-term channel characteristic measured from at least one time slot of the received signal for indicating a location of the interferer signal in the time slot of the received signal.

33. The mobile terminal of claim 30 wherein the channel characteristic is a first channel characteristic, and further comprising the channel quality estimator determining a second channel characteristic based on instantaneous noise values of the received signal and controlling demodulation of the received signal to compensate for the interferer signal responsive to the first and second channel characteristics.

34. The mobile terminal of claim 30 wherein the demodulator is a first demodulator and further comprising a second demodulator coupled to the radio processor and the channel quality processor for demodulating the filtered received signal, wherein the channel quality estimator selects one of the first demodulator and the second demodulator for demodulating the filtered received signal responsive to the channel characteristic.

35. The mobile terminal of claim 30 wherein the channel characteristic is calculated utilizing an adaptively changeable smoothing factor.

36. A base station for use in a mobile communications system comprising:
a base station receiver for receiving signals comprising a desired signal and an interferer signal;
a radio processor for filtering the received signals;
a demodulator coupled to the radio processor for demodulating the filtered signals; and
a channel quality estimator coupled to the demodulator for determining a channel characteristic based on instantaneous noise values of the signals for controlling the demodulation of the signals such that the desired signal is extracted by compensating for the interferer signal responsive to the channel characteristic.

37. The base station of claim 36 wherein the channel characteristic is a long-term channel characteristic measured from a plurality of time slots of the received signals for detecting the presence of an interferer in the received signals.

38. The base station of claim 36 wherein the channel characteristic is a short-term channel characteristic measured from at least one time slot of the received signals for indicating a location of the interferer signal in the time slot of the received signals.

39. The base station of claim 36 wherein the channel characteristic is a first channel characteristic, and further comprising the channel quality estimator determining a second channel characteristic based on instantaneous noise values of the received signals and controlling demodulation of the received signals to compensate for the interferer signal responsive to the first and second channel characteristics.

40. The base station of claim 36 wherein the demodulator is a first demodulator and further comprising a second demodulator coupled to the radio processor and the channel quality processor for demodulating the filtered received signals, wherein the channel quality estimator selects one of the first demodulator and the second demodulator for demodulating the filtered received signals responsive to the channel characteristic.

41. The base station of claim 36 wherein the channel characteristic is calculated utilizing an adaptively changeable smoothing factor.

42. A mobile communications system for compensating for interferer signals comprising:
a plurality of transmitters each transmitting a corresponding signal, one of the signals being a desired signal and the other signals being interfering signals; and
a receiver for receiving a signal comprising the desired signal and the interferer signal and including a radio processor for filtering the signal, a demodulator coupled to the radio processor for demodulating the filtered signal, and a channel quality estimator coupled to the demodulator for determining a channel characteristic based on instantaneous noise values of the signal for controlling the demodulation of the signal such that the desired signal is extracted by compensating for the interferer signal responsive to the channel characteristic.

43. The mobile communications system of claim 42 wherein the channel characteristic is a long-term channel characteristic measured from a plurality of time slots of the received signal for detecting the presence of an interferer in the received signal.

44. The mobile communications system of claim 42 wherein the channel characteristic is a short-term channel characteristic measured from at least one time slot of the received signal for indicating a location of the interferer signal in the time slot of the received signal.

45. The mobile communications system of claim 42 wherein the channel characteristic is a first channel characteristic, and further comprising the channel quality estimator determining a second channel characteristic based on instantaneous noise values of the received signal and controlling demodulation of the received signal to compensate for the interferer signal responsive to the first and second channel characteristics.

46. The mobile communications system of claim 42 wherein the demodulator is a first demodulator and further comprising a second demodulator coupled to the radio processor and the channel quality processor for demodulating the filtered received signal, wherein the channel quality estimator selects one of the first demodulator and the second demodulator for demodulating the filtered received signal responsive to the channel characteristic.

47. The mobile communications system of claim 42 wherein the channel characteristic is calculated utilizing an adaptively changeable smoothing factor.

48. A receiver for compensating for an interferer signal in a received signal comprising:
a radio processor for filtering the received signal;
a selector coupled to the radio processor;
a single user demodulator coupled to the selector and adapted for demodulating the received signal comprising little or no interferer signal, for demodulating the filtered received signal;
a multiuser demodulator coupled to the selector and adapted for demodulating the received signal comprising the interferer signal, for demodulating the filtered received signal; and
a channel quality estimator coupled to the radio processor, the selector and the single user demodulator, for determining a channel characteristic based on instantaneous noise values of the received signal as demodulated by the single user demodulator, and for controlling the selector to select one of the single user demodulator and the multiuser demodulator for demodulating the received signal to compensate for the interferer signal responsive to the channel characteristic.

49. The receiver of claim 48 wherein the channel characteristic is a long-term channel characteristic measured from a plurality of time slots of the received signal for detecting the presence of an interferer in the received signal.

50. The receiver of claim 48 wherein the channel characteristic is a short-term channel characteristic measured from at least one time slot of the received signal for indicating a location of the interferer signal in the time slot of the received signal.

51. The receiver of claim 48 wherein the channel characteristic is a first channel characteristic, and further comprising the channel quality estimator determining a second channel characteristic based on instantaneous noise values of the received signal and controlling the selector responsive to the first and second channel characteristics.

52. The receiver of claim 48 wherein the channel characteristic is calculated utilizing an adaptively changeable smoothing factor.

53. A receiver for compensating for an interferer signal in a received signal comprising:
a radio processor for filtering the received signal;
a single user demodulator coupled to the radio processor and adapted for demodulating the received signal comprising little or no interferer signal, for demodulating the filtered received signal;
a multiuser demodulator coupled to the radio processor and adapted for demodulating the received signal comprising the interferer signal, for parallel demodulation of the filtered received signal;
a combiner coupled to the single user demodulator and to the multiuser demodulator, having a combiner output node; and
a channel quality estimator coupled to the single user demodulator and to the combiner, for determining a channel characteristic based on instantaneous noise values of the received signal as demodulated by the single user demodulator, and for controlling the combiner to select one of the signals provided by the single user demodulator and the multiuser demodulator to be provided at the combiner output node responsive to the channel characteristic to compensate for the interferer signal.

54. The receiver of claim 53 wherein the channel characteristic is a long-term channel characteristic measured from a plurality of time slots of the received signal for detecting the presence of an interferer in the received signal.

55. The receiver of claim 53 wherein the channel characteristic is a short-term channel characteristic measured from at least one time slot of the received signal for indicating a location of the interferer signal in the time slot of the received signal.

56. The receiver of claim 53 wherein the channel characteristic is a first channel characteristic, and further comprising the channel quality estimator determining a second channel characteristic based on instantaneous noise values of the received signal and controlling the combiner responsive to the first and second channel characteristics.

57. The receiver of claim 53 wherein the channel characteristic is calculated utilizing an adaptively changeable smoothing factor.

58. A receiver for compensating for an interferer signal in a received signal comprising:
a radio processor for filtering the received signal;
a selector coupled to the radio processor;
a single user demodulator coupled to the selector and adapted for demodulating the received signal comprising little or no interferer signal, for demodulating the filtered received signal;
a multiuser demodulator coupled to the selector and adapted for demodulating the received signal comprising the interferer signal, for demodulating the filtered received signal; and
a switched time estimator coupled to the radio processor and the selector for determining which portion of the received signal contains a dominant interferer signal and which portion of the received signal does not contain a dominant interferer signal, and for controlling the selector to select one of the single user demodulator and the multiuser demodulator for demodulating the received signal to compensate for the interferer signal responsive to a portion of the received signal, if any, containing a dominant interferer signal.

59. The receiver of claim 58 wherein the switching time estimator utilizes edge detection of averaged short-term channel characteristics from the single user demodulator to detect the presence of the interferer signal.
